(19) United States
(12) Patent Application Publication
(10) Pub. No.: US 2026/0227684 A1
(43) Pub. Date: Aug. 6, 2026

(54) DECORATIVE ITEM WITH HOLOGRAPHIC ILLUSION

(71) Applicant: MINDSCOPE PRODUCTS, GLENDALE, CA (US)

(72) Inventor: GEORGE BALANCHI, GLENDALE, CA (US)

(73) Assignee: MINDSCOPE PRODUCTS, GLENDALE, CA (US)

(21) Appl. No.: 19/043,439

(22) Filed: Feb. 1, 2025

(51) Int. Cl. G03B 21/28; G03B 21/00; H04R 1/02

(52) U.S. Cl. CPC G03B 21/28; G03B 21/006; H04R 1/028; H04R 2499/15

(57) ABSTRACT

In general, the present invention is directed to a decorative item including: a body, comprising a cavity therein, the cavity being viewable through an opening; a projector, including: a light source; and a liquid crystal display (LCD) screen; the projector disposed in the cavity, but not viewable through the opening; a transparent element, positioned in the cavity, such that the transparent element is viewable through the opening; and the transparent element configured to receive or reflect projections of images or animations from the projector.

### FIELD OF THE INVENTION

The present invention is generally directed to a decorative item that includes an illusion or a hologram. More specifically, the present invention utilizes aspects of what is known as “Pepper's Ghost” along with a projector to provide for an improved holographic presentation.

### BACKGROUND

Various illusions may be used to create the image of a hologram, often used to show ghosts, ghouls, etc. such holograms may be created in a number of manners including what is known as “Pepper's Ghost.” Pepper's Ghost is a well-known illusion developed in the 1800s in which a transparent material within a user's field of vision reflects a person, item, etc. that is outside of the user's field of vision, thereby appearing as a “ghost.”

However, the sharpness and fidelity of the a reflected image may be less than desirable, particularly when reflecting a backlit item. Some variations of Pepper's Ghost may utilize a screen, such as a liquid crystal display (LCD), as generally known in the art. However, the necessary proximity of such an LCD screen to the transparent material often makes it difficult to hide the LCD screen, which may jeopardize the illusion. The further the LCD screen is located from the transparent material, however, the blurrier and more scattered the illusion.

It is desirable to provide an image or animation source for a holographic display that will adequately conceal or hide the image source, so as not to destroy the illusion, but also maintain sharpness and fidelity of the holographic image.

### SUMMARY OF THE INVENTION

In accordance with some embodiments of the present invention, aspects may include a decorative item including: a body, comprising a cavity therein, the cavity being viewable through an opening; a projector, including: a light source; and a liquid crystal display (LCD) screen; the projector disposed in the cavity, but not viewable through the opening; a transparent element, positioned in the cavity, such that the transparent element is viewable through the opening; and the transparent element configured to receive or reflect projections of images or animations from the projector.

In accordance with some embodiments of the present invention, aspects may include a decorative item comprising: a body, comprising a cavity therein, the cavity being viewable through an opening; one or more barriers, separating the cavity into viewable and non-viewable portions; a projector, comprising: a light source; and a liquid crystal display (LCD) screen; and one or more lenses, filters, or reflective cones; the projector disposed in the cavity, but not viewable through the opening; a transparent element, positioned in the cavity, such that the transparent element is viewable through the opening, the transparent element having a planar, curved, or partially spherical shape and configured to receive or reflect projections of images or animations from the projector; a speaker, the speaker configured to output audio associated with the images or animations; the image or animation reflected on the transparent element being viewable through the opening of from any position.

In accordance with some embodiments of the present invention, aspects may include a lantern shaped decorative element comprising: a body, comprising a cavity therein, the cavity being viewable through an opening; one or more barriers, separating the cavity into viewable and non-viewable portions; a projector, comprising: a light source; and a liquid crystal display (LCD) screen; and one or more lenses, filters, or reflective cones; the projector disposed in the cavity, but not viewable through the opening; a transparent element, positioned in the cavity, such that the transparent element is viewable through the opening, the transparent element having a planar, curved, or partially spherical shape and configured to receive or reflect projections of images or animations from the projector; one or more mirrors, the one or more mirrors used to redirect the images or animations from the projector to the transparent element; a speaker, the speaker configured to output audio associated with the images or animations; the image or animation reflected on the transparent element being viewable through the opening of from any position.

These and other aspects will become apparent from the following description of the invention taken in conjunction with the following drawings, although variations and modifications may be affected without departing from the scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary arrangement of a projector and transparent material, in accordance with some embodiments of the present invention.

FIG. 2 illustrates an exemplary arrangement of a projector and transparent material, in accordance with some embodiments of the present invention.

FIGS. 3A and 3B illustrates an exemplary arrangement of a projector and transparent material configured in a housing shaped as a lamp or lantern, in accordance with some embodiments of the present invention.

FIG. 4 illustrates an exemplary arrangement of a projector and transparent material, in accordance with some embodiments of the present invention.

FIG. 5 illustrates an exemplary arrangement of a projector and transparent material, in accordance with some embodiments of the present invention.

FIG. 6 illustrates an exemplary arrangement of a projector and transparent materials, in accordance with some embodiments of the present invention.

FIGS. 7A-7C illustrates an exemplary arrangement of a projector and transparent material disposed in a decorative item shaped as a pumpkin, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

### General Discussion

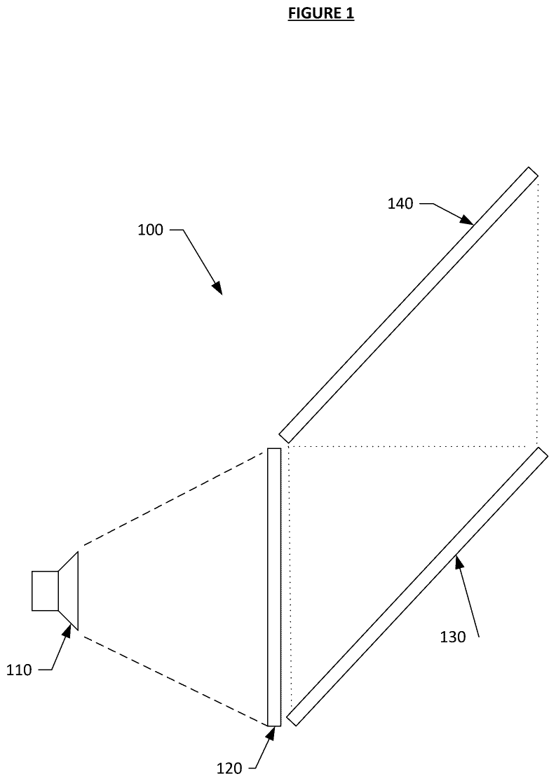

With reference to FIG. 1, a first exemplary system 100 of a projector and transparent material in accordance with some embodiments of the present invention will now be discussed. First system 100 comprises a light source 110, an LCD screen 120, a reflective surface 130, and a transparent surface 140. Light source 110 may comprise a light emitting diode (LED), an incandescent light, and/or any other light emitting device as known in the art. LCD screen 120 may receive and display various images or animations, which may be received, for example, from a processor. Images or animations displayed on the LCD screen 120 may be reflected by reflective surface 130, which may comprise a mirror, polished surface, or other reflective material. Transparent surface 140 may comprise glass, acrylic, quartz, cellophane, plastics, etc., and/or any other material as known in the art. The transparent surface 140 may display the image as reflected from the LCD screen 120 via the mirror 130.

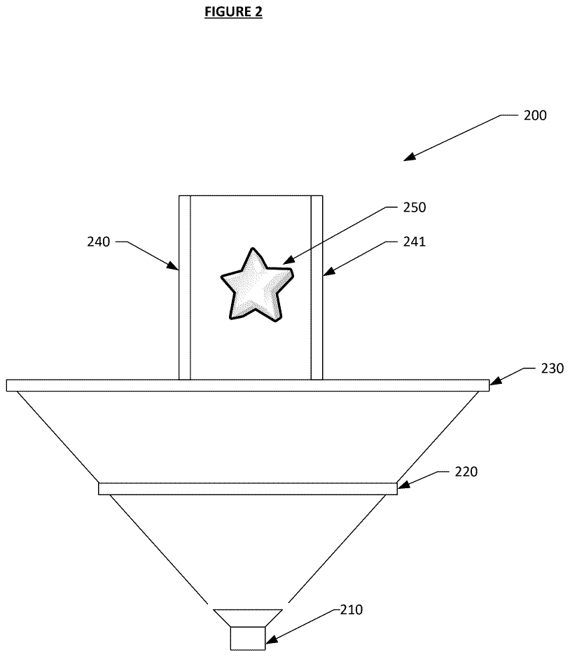

With referent to FIG. 2, a second exemplary system 200 of a projector and transparent material in accordance with some embodiments of the present invention will now be discussed. Second system 200 comprises a light source 210, an LCD screen 220, a first transparent surface 230, and one or more second transparent surfaces 240.

In general, light source 210 may comprise a light emitting diode (LED), an incandescent light, and/or any other light emitting device as known in the art. LCD screen 220 may receive and display various images or animations, which may be received, for example, from a processor. Images or animations displayed on the LCD screen 220 may be displayed by first transparent surfaces 230, which may comprise glass, acrylic, quartz, cellophane, plastics, etc., and/or any other material as known in the art. The first transparent surface 140 may display the image as received from the LCD screen 220. The image or animations as received by the first transparent surface 140 may then be reflected onto second transparent surface 240. In this manner, images projected from the LCD screen 220 maybe reflected by the second transparent surface 240, giving a visual representation of a hologram 250.

The second exemplary system 200 may have second reflective surfaces 240 arranged in a shape of a triangle, square, or other polygon. In this manner, a viewer may be presented with the illusion of the hologram 250 from various locations around the second exemplary system 200.

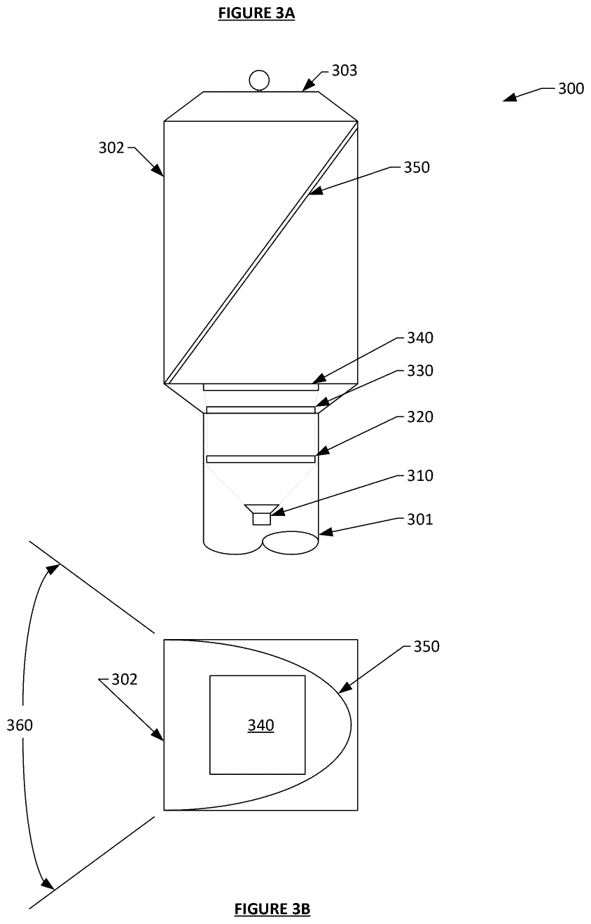

FIGS. 3A and 3B illustrate a front view and a side view, respectively, of a third exemplary system 300 of a projector and transparent material as known in the art. With reference to FIG. 3A, third exemplary system 300 may be in a variety of configurations, including without limitation a lantern or light post, as illustrated. System 300 may comprise a post portion 301, a lantern portion 302 (which may be comprised of clear material through which a viewer or user may see an illusion therein, and/or a cap 303. Note that such lanterns may be holiday themed, may include licensed material (such as cartoon characters, etc.), and may take any shape or size as known in the art.

A light source 301 shine a light through one or more optional lenses and/or filters 310, such as but not limited to a Fresnel lens 320, which in turn may direct light to and/or through an LCD screen 330. Additional lenses and/or filters 340 may be used to directed, filter, focus, contour, and/or otherwise treat or modify the projected image or animations. Image or animations may then be projected onto transparent material 350, which reflect the image in such a manner as to be viewable by a user outside of the lantern.

With reference to FIG. 3B it can be seen that transparent material 350 may be curved. In this manner, any image projected from the LED 310, lenses or filters 320, 340, and LCD screen 330 may be reflected across a curved surface, which may in turn allow a user viewing through lantern portion 302 to see the reflected image through any position in filed of view 360.

Note that while the exterior configuration of the third exemplary system 300 is in the shape of a lantern or light post, it is contemplated by the present invention that the exterior may be in any configuration, including for example, a pumpkin, snowman, crystal ball, head, house, etc.

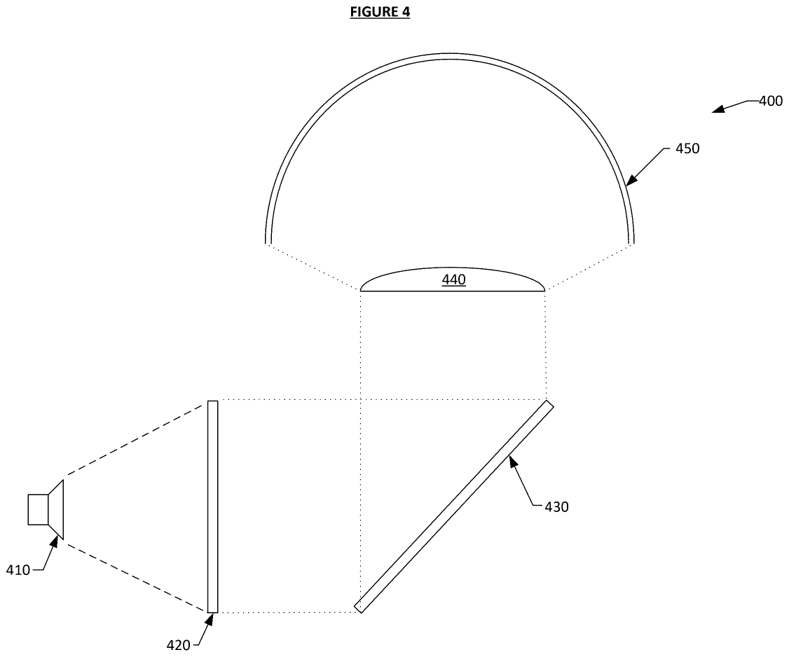

With reference to FIG. 4, a fourth embodiment of an exemplary system 400 will now be discussed. Exemplary system 400 may comprise a light source 410, an LCD screen 420, a reflective surface 430, a half-ball or fisheye lens 440, and a domed or partially spherical transparent surface 450. In this manner, images or animations displayed on LCD screen may be projected and reflected onto dome or partially spherical transparent surface 450, which may present users with both nearly three hundred and sixty (360) degrees of a field of view, and/or may be utilize to present an illusion of a three dimensional hologram.

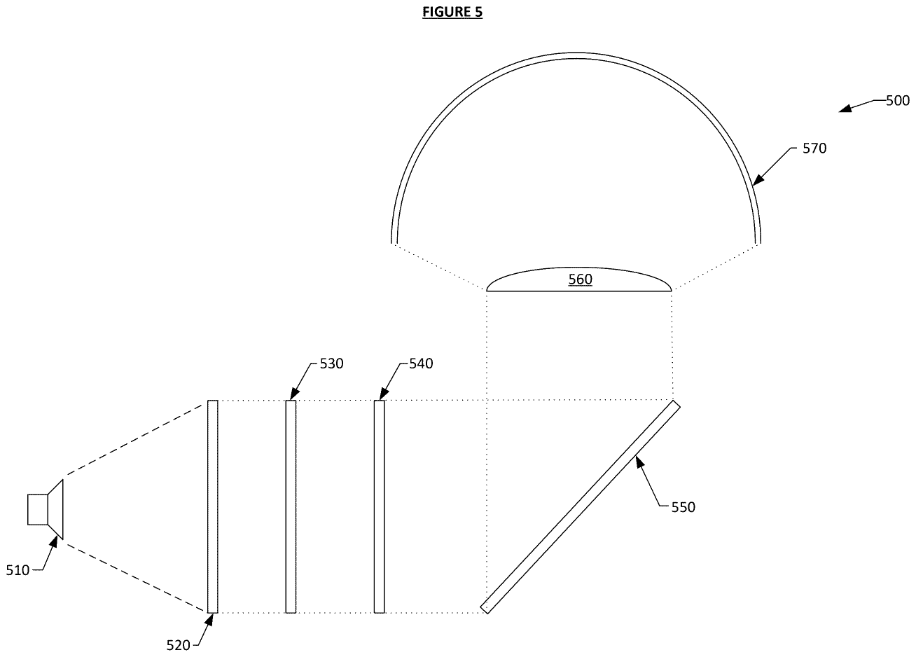

With reference to FIG. 5, a fifth embodiment of an exemplary system 500 will now be discussed. Exemplary system 500 may comprise a light source 510, one or more lenses or filters 520, 540, an LCD screen 530, a reflective surface 550, a fisheye or half ball or semi-spherical lens 560, and a domed or partially spherical transparent surface 570. In this manner, images or animations displayed on LCD screen may be projected and reflected onto dome or partially spherical transparent surface 570, which may present users with both nearly three hundred and sixty (360) degrees of a field of view, and/or may be utilize to present an illusion of a three dimensional hologram.

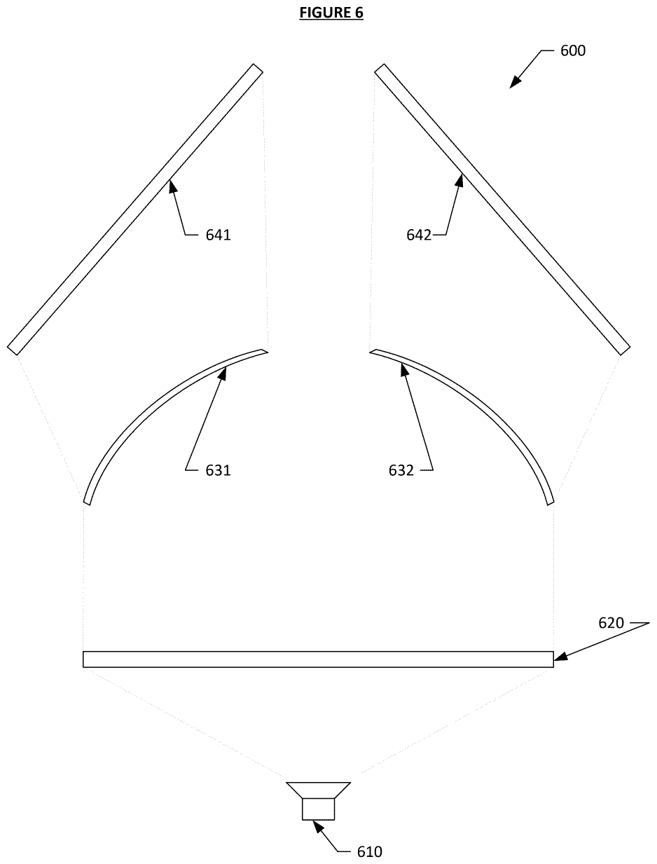

With reference to FIG. 6, a sixth embodiment of an exemplary system 600 will now be discussed. Exemplary system 600 may be utilized to split a single projection into two or more holographic projections. More specifically, system 600 may comprise a light source 610, an LCD screen 620, two or more lenses 630, 631, which may be used to direct the projected image or animations onto two or more transparent materials 640, 641. The projections may be layered, creating a more complete or three dimensional illusion.

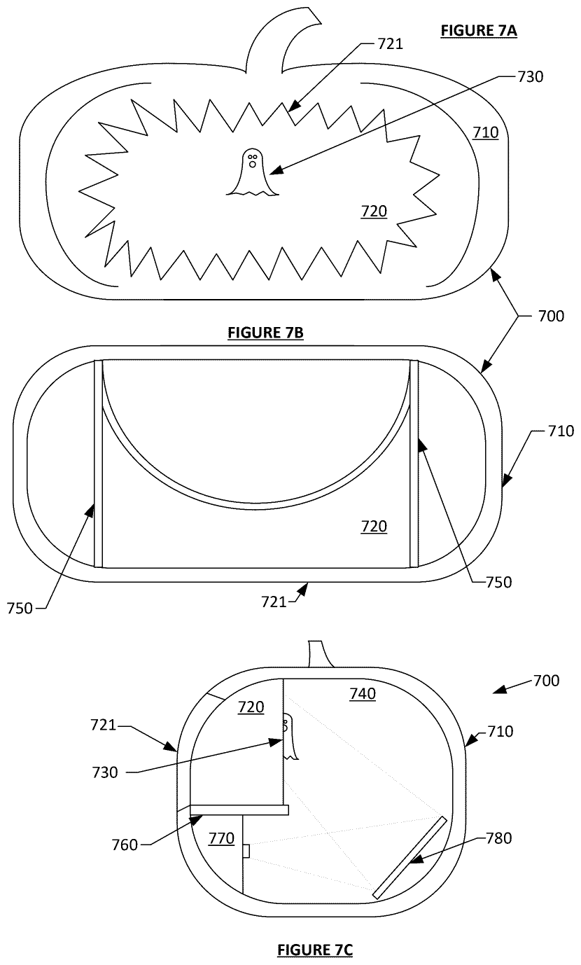

FIGS. 7A-7C illustrate an exemplary arrangement of a projector and transparent material disposed in a decorative item shaped as a pumpkin 700, in accordance with some embodiments of the present invention. Pumpkin 700 may be of a generally spherical shape, comprising a body 710 with a cavity therein 720. The cavity 720 may be viewable through opening 721. A holographic illusion 730 may be visible in the cavity 720.

With reference to FIG. 7B, a transparent surface 740 is visible, curved inside the cavity 720. One or more barriers 750 may also be present in the cavity 720 to restrict either the volume of the cavity, to limit a user's field of vision, or to provide structural support to the pumpkin and/or any components therein.

With reference to FIG. 7C pumpkin 700 can be seen comprising body 710, cavity 720 visible through opening 721, transparent surface within the cavity 740, projected and reflected holographic illusion 730, a barrier floor 760, which may block from view a projector 770 and a reflective surface 780. In this arrangement, projector 770 may project an image or animation onto reflective surface 780, which may reflect the image or animation onto the transparent surface 740, which may be visible to a user or observer through opening 721.

As discussed herein, the present invention is generally directed to a decorative item with a projector, the projector capable of projecting images and/or animations on to, or reflected by a transparent surface within the decorative item. Such decorative item may be themed in accordance with a particular holiday or event. For example, the decorative item may display a holographic illusion of a ghost, ghoul, or monster for Halloween, falling leaves for fall, reindeer, snowman, Santa Claus, decorated trees, etc. for Christmas or winter, an bunny or chick for Easter, etc. Any character or item may be used, even if not themed to a holiday or event. For example, the holographic illusion may be of a dog, cat, or any animal; unicorn, monster, dragon, or any imaginary creature; even an animated house, rock, tool, etc. may be utilized.

Note that when it is discussed that the decorative item is themed, this is predominantly directed to the outside shape of the decorative item, which may be made out of any suitable material, including plastic, wood, metal, composite materials, ceramic materials, etc.

Projection systems may vary in both resolution, throw (and potential use of mirrors or other mechanisms to increase throw), etc.

Note that in accordance with some embodiments of the present invention, the decorative item may include one or more speakers to play various sounds, songs, sayings, etc., which may correspond with animations to appear as if the decorative item is talking, singing, etc. Indeed, in accordance with some embodiments of the present invention, the decorative item may predominantly comprise a wireless speaker (for example, a Bluetooth speaker), with a screen for displaying different graphics, images, shapes, animations, etc., in accordance with the holographic illusion as discussed herein. It is also considered that images, animations, videos, and/or other data may also be cast or sent to the a holographic display incorporated into the decorative item/speaker.

It is also contemplated that various devices may be configured to access various libraries of statements, songs, jokes, etc. This may be useful for multiple reasons. For example, during holiday season a snowman may be configured to draw statements, jokes, songs, etc. from a data base of Christmas items, or a database of Channukah items. In a different variation, a decorative item in the home of a family with young children may draw upon younger jokes or more accessible statements, while an item in a predominantly adult household may be configured for more adult content, for example more risqué jokes or innuendos.

In accordance with some embodiments of the invention, the projector may play recorded, live, real-time, or near real-time via the projector onto the “face” of the decorative item. In this manner, anyone with a corresponding application may record video—or provide a real-time or near real-time video feed. This video or video feed may be projected by the projector onto or reflected by the transparent surface.

The projector and/or accessories, such as a speaker and/or a storage device, may be situated within the plastic enclosure. The animated images can be updateable by the user, allowing for a wide variety of animated images, songs, and the like, which can be customized for individual users. In at least one embodiment, the described device projects customizable animated images onto the interior surface of an enclosure in the form of a decorative plastic figure. An internal storage device (such as an SD card) and/or communications device (such as Bluetooth or Wi-Fi receiver) stores and/or receives audio and/or images, such as static and/or animated images. Animated images can be received from a computing device such as a smartphone or other device, and/or from the Internet. In at least one embodiment, a user can purchase and/or download animated images via a computer or smartphone, for playback on the device.

In at least one embodiment, the decorative item may connect with and communicate with other devices, such as a computing device such as a smartphone, via wired or wireless communication. In this way, the device can be made to project static images, animated images,

music, and/or audio as directed by the consumer operating the computing device. In at least one embodiment, a remote control can be provided, to allow a user to select among a number of different projections, and/or to control the device in other ways (e.g. to change volume, download additional images, power on/off, and/or the like). Alternatively, such control can be provided via an app running on the computing device.

In at least one embodiment, the device is self-contained; the projector and other components are situated inside the enclosure so that no external projector is required. A power supply (such as a battery) can be included within the enclosure; alternatively, a power cord can be provided that allows the device to be powered from an external source.

In at least one embodiment, the transparent surface may be concave and/or irregular. In at least one embodiment, 3D-printed shape-specific lenses and/or mirrors can be used, to enable image focus on an uneven transparent surface.

It is contemplated that while the specific embodiments discussed above comprise lanterns, items, etc., decorative items and/or items including the holographic illusion of the present invention may comprise any shape or size. For example, it is contemplated that the present inventio be utilized in “life sized” items, such as doorways, walkways, archways, telephone booths, etc. Similarly, the present invention may also be utilized in smaller items, such as ornaments, toys (such as but not limited to, toy cars or vehicles, action figures, dolls, etc.), night lights, etc.

It is contemplated that additional elements may be provided to further either the holographic illusion or to create a more interesting, “spooky,” or aesthetically pleasing item. For example, additional mirrors may be added to create an “infinity” mirror effect, with the holographic illusion projected or reflected therein. Picture frames may be utilized such that the decorative item appears to be one thing (a traditional picture), but then offers illusions to entertain the user or viewer.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

1. A decorative item comprising:
a body, comprising a cavity therein, the cavity being viewable through an opening;
a projector, comprising:
a light source; and
a liquid crystal display (LCD) screen;
the projector disposed in the cavity, the projector being located outside of sightlines through the opening;
a transparent element, positioned inside the cavity, such that the transparent element is viewable through the opening;
the transparent element configured to reflect projections of images or animations from the projector.

2. The decorative item of claim 1, wherein the cavity comprises one or more barriers to reduce what is viewable through the opening.

3. The decorative item of claim 1, wherein the projector further comprises one or more lenses, filters, or reflective cones.

4. The decorative item of claim 1, further comprising one or more mirrors, wherein the one or more mirrors are used between the projector and the transparent element to redirect the images or animations from the projector.

5. The decorative item of claim 2, wherein the projector is not viewable through the opening because it is blocked by a barrier.

6. The decorative item of claim 1, wherein the transparent element is generally planar.

7. The decorative item of claim 1, wherein the transparent element is curved.

8. The decorative item of claim 1, wherein the transparent element is dome-shaped or partially spherical.

9. The decorative item of claim 1, further comprising a speaker, configured to audibly output sounds associated with the images or animations.

10. The decorative item of claim 1, wherein the body is configured in the shape of a lantern.

11. The decorative item of claim 1, wherein the body is configured in the shape of a pumpkin.

12. The decorative item of claim 7, wherein the image or animation reflected on the transparent element is viewable through the opening of from any position.

13. A decorative item comprising:
a body, comprising a cavity therein, the cavity being viewable through an opening;
one or more barriers, separating the cavity into viewable and non-viewable portions;
a projector, comprising:
a light source; and
a liquid crystal display (LCD) screen; and
one or more lenses, filters, or reflective cones;
the projector disposed in the cavity, the projector being located outside of sightlines through the opening;
a transparent element, positioned in the cavity, such that the transparent element is located within sightlines through the opening, the transparent element having a planar, curved, or partially spherical shape and configured to reflect projections of images or animations from the projector;
a speaker, the speaker configured to output audio associated with the images or animations;
the image or animation reflected on the transparent element.

14. The decorative item of claim 1, wherein the body is configured in the shape of a lantern or a pumpkin.

15. A lantern shaped decorative element comprising:
a body, comprising a cavity therein, the cavity being viewable through an opening;
one or more barriers, separating the cavity into viewable and non-viewable portions;
a projector, comprising:
a light source; and
a liquid crystal display (LCD) screen; and
one or more lenses, filters, or reflective cones;
the projector disposed in the cavity, the projector being located outside of sightlines through the opening;
a transparent element, positioned in the cavity, such that the transparent element is within sightlines through the opening, the transparent element having a planar, curved, or partially spherical shape and configured to reflect projections of images or animations from the projector;
one or more mirrors, the one or more mirrors used to redirect the images or animations from the projector to the transparent element;
a speaker, the speaker configured to output audio associated with the images or animations;
the image or animation reflected on the transparent element.
